(19) United States
(12) Patent Application Publication
(10) Pub. No.: US 2017/0077725 A1
(43) Pub. Date: Mar. 16, 2017

(54) BATTERY SYSTEM WITH OVERCHARGE AND/OR EXHAUSTIVE-DISCHARGE PROTECTION

(71) Applicant: Lithium Energy and Power GmbH & Co. KG, Stuttgart (DE)

(72) Inventor: Marcel Wilka, Yodogawa (JP)

(21) Appl. No.: 15/258,709

(22) Filed: Sep. 7, 2016

(30) Foreign Application Priority Data
Sep. 10, 2015 (EP) 15184664.9

(51) Int. Cl. H02J 7/00; H01M 12/08; H01M 10/44; H01M 10/46; H01M 10/0525

(52) U.S. Cl. CPC H02J 7/0029; H02J 7/0072; H02J 7/0045; H01M 10/46; H01M 10/0525; H01M 10/44; H01M 12/08; H02J 2007/0037; H02J 2007/004

(57) ABSTRACT

Battery system with overcharge and/or exhaustive-discharge protection, having a rapid-discharge unit for electrically discharging an electrical energy store having a first connection which is electrically connected to a first pole, characterized in that the battery system comprises a tripping unit having an electrically conductive mechanical component for tripping the rapid-discharge unit, wherein the mechanical component is electrically connected directly to a second pole by an electrically conductive housing of the electrical energy store and/or by an electrical connection.

### BACKGROUND OF THE INVENTION

The invention proceeds from a battery system with overcharge and/or exhaustive-discharge protection, comprising at least one electrical energy store having a first pole which is electrically connected to a first electrode of the electrical energy store, having a second pole which is electrically connected to a second electrode of the electrical energy store, having a rapid-discharge unit for electrically discharging the electrical energy store having a first connection which is electrically connected to the first pole, and having a second connection which is electrically connected to the second pole.

Document DE 10 2011 015 829 A1 discloses an electrochemical energy storage cell having a current-interruption device for interrupting at least one electrical connection of the energy storage cell, which electrical connection is provided for operating the energy storage cell. Furthermore, the energy storage cell has a discharge device which allows complete or partial discharge of the energy storage cell when at least one electrical connection of the energy storage cell, which electrical connection is provided for operating the energy storage cell, is interrupted by the current-interruption device. This allows discharging of the energy storage cell and therefore safe transportation and safe storage of the energy storage cell while at the same time preventing further operation of the energy storage cell which may have been damaged by overcharging.

Document DE 10 2012 219 082 A1 discloses a safety apparatus for arrangement in a battery cell of a lithium-ion battery, comprising at least one planar metal conductor, in particular a metal printed circuit board or metal foil, to which an insulation layer is attached and which has a pole contact-making means for electrical connection to a pole of the battery cell, wherein the conductor has at least one heating resistor which is arranged on the insulation layer and has a first and a second contact-making means, wherein an electric current can be conducted through the heating resistor via the contact-making means.

### SUMMARY OF THE INVENTION

The procedure according to the invention has the advantage over said prior art that the battery system comprises a tripping unit having an electrically conductive mechanical component for tripping the rapid-discharge unit, wherein the mechanical component is electrically connected directly to the second pole by means of an electrically conductive housing of the electrical energy store and/or by means of an electrical connection. As a result, an electrical energy store of the battery system can advantageously be very rapidly discharged and the battery system is moved to a safe state.

The rapid-discharge unit comprises a rapid-discharge circuit by means of which rapid discharge of the electrical energy store is advantageously ensured. Furthermore, the rapid-discharge unit can be matched to any desired battery systems by suitable design of the rapid-discharge circuit.

The rapid-discharge circuit comprises a discharge circuit comprising power semiconductors and a half-bridge. As a result, the electrical energy store can be rapidly discharged and moved to a safe state.

The mechanical component of the tripping unit is reversibly or irreversibly deformable owing to a force which acts on the mechanical component, for example a pressure increase in the battery system. The electrically conductive connection between the conductor and the contact-making means of the rapid-discharge unit is disconnected owing to the reversible deformation after the electrical energy store returns to a normal operating state, as a result of which the electrical energy store is again available to the battery system. If the mechanical component is irreversibly deformed, the electrical energy store remains permanently disconnected from the battery system, as a result of which recommissioning of the electrical energy store is advantageously prevented.

The mechanical component of the tripping unit can be both designed as an additional component and/or realized by means of an existing component, for example an overpressure valve.

For the purpose of discharging the electrical energy store, the method according to the invention for driving a rapid-discharge unit of the discharge circuit of the battery system switches on a power semiconductor in a half-bridge of the rapid-discharge circuit and operates another power semiconductor of the discharge circuit in an active mode as a controllable resistor.

The battery system according to the invention is advantageously used in a vehicle having at least one electrical energy store, as a result of which applicable safety standards can be complied with a comparatively low level of expenditure.

The electrical energy store is advantageously a lithium-ion, a lithium-sulfur and/or a lithium-air battery. It is advantageous to rapidly move to a safe state particularly in these types of electrical energy stores due to possible chemical secondary reactions.

### BRIEF DESCRIPTION OF THE DRAWINGS

In the drawing:

FIG. 1 shows a first embodiment of the battery system according to the invention; and

FIG. 2a shows a second embodiment of the battery system according to the invention; and

FIG. 2b shows the second embodiment of the battery system according to the invention in an abnormal operating state of the electrical energy store; and

FIG. 3 shows an embodiment of a rapid-discharge circuit; and

FIG. 4a shows a first embodiment of a mechanical component of a tripping unit of the battery system according to the invention; and

FIG. 4b shows a second embodiment of a mechanical component of a tripping unit of the battery system according to the invention; and

FIG. 4c shows a third embodiment of a mechanical component of a tripping unit of the battery system according to the invention.

### DETAILED DESCRIPTION

Like reference symbols denote like apparatus components in all of the figures.

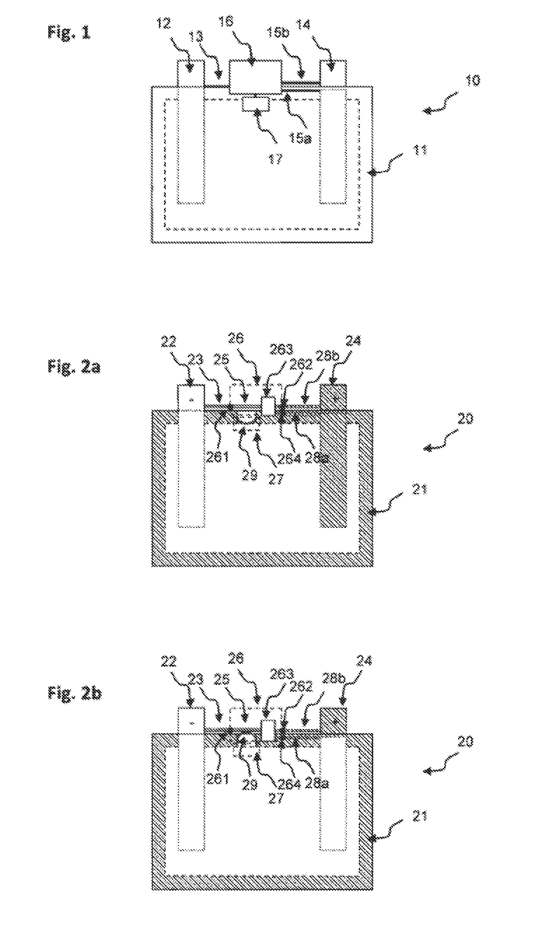

FIG. 1 shows a first embodiment of the battery system 10 according to the invention having at least one electrical energy store, having a first pole 12 which is electrically connected to a first electrode of the electrical energy store, having a second pole 14 which is electrically connected to a second electrode of the electrical energy store, having a rapid-discharge unit 16 for electrically discharging the electrical energy store having a first connection which is electrically connected to the first pole, for example by means of an electrical connection 13, having a second connection which is electrically connected to the second pole, for example by means of an electrical connection 15, a tripping unit 17 for tripping the rapid-discharge unit 16, and also a housing 11 of the electrical energy store.

The tripping unit 17 can be both designed as an additional component or realized by means of an existing component, for example an overpressure valve in hard-case cells, as a result of which components are advantageously saved.

FIG. 2a shows a second embodiment of the battery system 20 according to the invention in a normal operating state of an electrical energy store. The electrical energy store comprises a first pole 22, for example a negative pole, which is electrically connected to a rapid-discharge unit 26 by means of an electrical connection 23 to a first connection 261, and also a second pole 24, for example a positive pole of the electrical energy store, which is electrically connected to the rapid-discharge unit 26 by means of an electrical connection 28b to a second connection 262, a third connection 264 which is electrically connected to an electrode of the second pole 24 and also a tripping unit 27 comprising a mechanical component 29 which is electrically conductive and is electrically connected to the second pole 24 by means of the electrically conductive housing 21 of the electrical energy store. The mechanical component 29 of the tripping unit 27 is reversibly or irreversibly deformable, for example owing to a force which acts on the mechanical component 29. The rapid-discharge unit 26 comprises a conductor 25 which is electrically connected to the electrical connection 23 by means of the first interface 261 and an electronic rapid-discharge circuit 263 which is electrically connected to the electrical connection 28b by means of the second interface 262 and is electrically connected to the electrical connection 28a by means of the third interface 264.

There is no electrical connection between the mechanical component 29 of the tripping unit 27 and the conductor 25 of the rapid-discharge unit 26 in the normal operating state of the electrical energy store.

FIG. 2b shows the second embodiment of the battery system 20 according to the invention in an abnormal operating state of the electrical energy store. An abnormal operating state of the electrical energy store occurs, for example, when said electrical energy store is charged by an excessive charging current, this leading, for example, to an increase in pressure in the interior of the housing 21 of the electrical energy store. Owing to the increase in pressure, the mechanical component 29 of the tripping unit 27 is reversibly or irreversibly deformed when a prespecifiable pressure is exceeded, as a result of which an electrical connection between the mechanical component 29 of the tripping unit 27 and the conductor 25 of the rapid-discharge unit 26 is produced. Owing to this electrical connection, a current flows between the second pole 24 and the first pole 22 across the conductive housing 21, the mechanical component 29, the conductor 25 and the line 23. The rapid-discharge unit 26, the rapid-discharge circuit 263 and/or a battery management system detects this flowing current, for example by means of an electrical connection to the conductor 25, and in response to this the rapid-discharge circuit 263 short-circuits and discharges the electrical energy store by means of the conductor 25 and the electrical connection 23 and/or by means of a direct electrical connection between the rapid-discharge circuit 263 and the first pole 22.

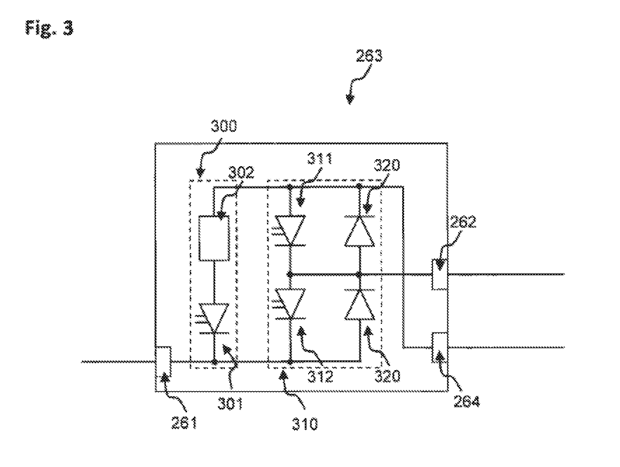

FIG. 3 shows an embodiment of a rapid-discharge circuit 263. If a monitoring and drive unit of the rapid-discharge unit 26, starting from a normal mode of the electrical energy store, identifies a threat of the electrical energy module being overcharged on the basis of a first voltage limit value being exceeded, the first power semiconductor 311 of a half-bridge 310 is switched off and the second power semiconductor 312 is switched on. Since the voltage lies within a minimum and maximum limit value, the diode 320 of the first power semiconductor 311 also turns off in the event of a threat of overcharging, for example in the event of a malfunction during charging of the electrical energy store. As a result, further charging of the electrical energy store can be reliably prevented.

If the monitoring and drive unit of the rapid-discharge unit 26, starting from a normal mode of the electrical energy store, identifies a threat of exhaustive discharge of the electrical energy store on the basis of a second voltage limit value being undershot, the first power semiconductor 311 of the half-bridge 310 is switched off and a second power semiconductor 312 is switched on. Current then no longer flows through the electrical energy store. A current may be output from the electrical energy store only by means of the power semiconductor 301 of the rapid-discharge circuit.

If the monitoring and drive unit of the rapid-discharge unit 26, starting from a normal mode of the electrical energy store, identifies a threat of overcharging of the electrical energy store due to excessively high discharge currents which can occur, for example, as a result of an external short-circuit of the electrical energy store, the first power semiconductor 311 of the half-bridge 310 is switched off and the second power semiconductor 312 is switched on. Current then no longer flows through the electrical energy store. The electrical energy store is protected against loading with impermissibly high discharge currents in this way.

If the monitoring and drive unit of the rapid-discharge unit 26, starting from a normal mode, identifies a threat of overcharging of the electrical energy store due to excessive charging currents, for example at very low temperatures, the first power semiconductor 311 of the half-bridge 310 is switched off by means of the monitoring and drive unit and the second power semiconductor 312 is switched on. Current then no longer flows through the electrical energy store. The electrical energy store is protected against loading with impermissibly high charging currents in this way.

If, for example in a vehicle, a battery management system informs the monitoring and drive unit of the battery system according to the invention that the vehicle has been involved in an accident, the electrical energy store can be discharged by means of the half-bridge 310. To this end, the second power semiconductor 312 is switched on and the first power semiconductor 311 is operated in the so-called active mode as a controllable resistor. The electrical energy store then does not output any voltage at its poles 22, 24 and is nevertheless slowly discharged. The discharge currents which can be realized are limited by the thermal power loss which can be imposed on the power semiconductor, which is operated as a controllable resistor, during long-term operation. A power semiconductor 311, which is operated in particular as a controllable resistor, together with its thermal connection arrangement and cooling arrangement, is therefore designed in accordance with the requirements.

The rapid-discharge unit 26 further comprises an ultra-fast discharge circuit (Ultra Fast Discharge Device, UFDD) 270, a series circuit comprising a power semiconductor 310 and a resistor 302. A discharge circuit 300 is provided in the rapid-discharge unit 26 in order to discharge the electrical energy store by means of a discharge current which flows through the discharge circuit 270. If a battery management system informs the monitoring and drive unit of the battery system that the vehicle has been involved in an accident, the electrical energy store is rapidly discharged by means of the discharge circuit 300.

In order to assist the discharge circuit 300, the electrical energy store can also be discharged by means of the half-bridge 310 at the same time. In order to assist the discharge circuit 300, the second power semiconductor 312 of the half-bridge 310 is therefore switched on by means of the monitoring and drive unit. The electrical energy store then does not output any voltage at its poles 22, 23 during the discharging operation. The discharge circuit 300 can be designed such that the electrical energy store can be discharged with very high discharge currents close to the short circuit. The electrical energy store is therefore moved very quickly to a safe state. In the process, the first power semiconductor 311, in a manner assisted by means of the monitoring and drive unit, can also be operated in the active mode as a controllable resistor.

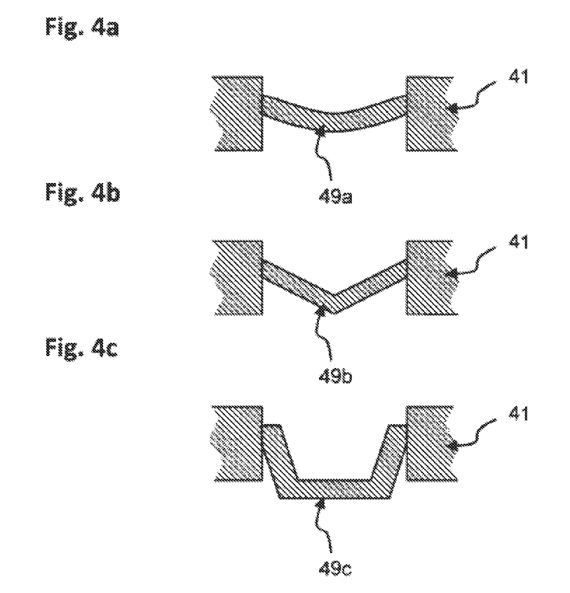

FIG. 4a shows a first embodiment of a mechanical component 49a, of a tripping unit of the operating system according to the invention. The mechanical component 49a is electrically conductively connected to a housing 41 of an electrical energy store. The mechanical component 49a of the shown tripping unit is reversibly or irreversibly deformable. In the embodiment shown, the mechanical component 49a is designed as a diaphragm, wherein the material used is an electrically conductive metal or metal alloy, a carrier material with an electrically conductive coating and/or an electrically conductive plastic. Owing to the selected shape of the mechanical component 49a, an increase in pressure in the interior of the electrical energy store equally acts on said mechanical component. A force with which the mechanical component 49a is deformed and which is to be exceeded is prespecified by the selected material of the mechanical component 49a.

FIG. 4b shows a second embodiment of a mechanical component 49b of a tripping unit of the battery system according to the invention. The mechanical component 49b is electrically connected to the housing 41 of the electrical energy store. A lower resistance between the mechanical component 49b and a conductor is achieved during deformation by the selected shape of the mechanical component 49b.

FIG. 4c shows a third embodiment of a mechanical component 49c of a tripping unit of the battery system according to the invention. A large-area connection between the mechanical component 49c and a conductor is achieved by the selected shape of the mechanical component 49c. Furthermore, movements of the housing 41 of the electrical energy store are compensated for, as a result of which damage to the mechanical component 49c is prevented.

What is claimed is:

1. A battery system (10, 20, 30) with overcharge and/or exhaustive-discharge protection, the battery system comprising at least one electrical energy store having a first pole (12, 22) which is electrically connected to a first electrode of the electrical energy store, and having a second pole (14, 24) which is electrically connected to a second electrode of the electrical energy store by means of a rapid-discharge unit (16, 26, 36) for electrically discharging the electrical energy store, wherein the rapid-discharge unit (16, 26, 36) has a first connection (261, 361) which is electrically connected to the first pole, wherein the battery system (10, 20, 30) comprises a tripping unit (17, 27, 37) having an electrically conductive mechanical component (29, 39, 49a, 49b, 49c) for tripping the rapid-discharge unit (17, 27, 37), wherein the mechanical component (29, 39, 49a, 49b, 49c) is electrically connected directly to the second electrode by at least one of an electrically conductive housing (11, 21) of the electrical energy store and by an electrical connection.

2. The battery system (10, 20) according to claim 1, characterized in that the rapid-discharge unit (16, 26) comprises a rapid-discharge circuit (263).

3. The battery system (10, 20) according to claim 2, characterized in that the rapid-discharge circuit (263) comprises a discharge circuit (300) and a half-bridge (310).

4. The battery system (10, 20) according to claim 3, characterized in that the mechanical component (29, 39, 49a, 49b, 49c) of the tripping unit (17, 27, 37) is reversibly or irreversibly deformable owing to a force which acts on the mechanical component (29, 39, 49a, 49b, 49c).

5. The battery system (10, 20) according to claim 1, characterized in that the mechanical component (29, 39, 49a, 49b, 49c) of the tripping unit (17, 27, 37) is reversibly or irreversibly deformable owing to a force which acts on the mechanical component (29, 39, 49a, 49b, 49c).

6. The battery system (10, 20) according to claim 1, wherein the mechanical component (29, 39, 49a, 49b, 49c) is electrically connected directly to the second electrode by the electrically conductive housing (11, 21) of the electrical energy store.

7. The battery system (10, 20) according to claim 1, wherein the mechanical component (29, 39, 49a, 49b, 49c) is electrically connected directly to the second electrode by the electrical connection.

8. The battery system (10, 20) according to claim 1, wherein the mechanical component (29, 39, 49a, 49b, 49c) is electrically connected directly to the second electrode by both of the electrically conductive housing (11, 21) of the electrical energy store and the electrical connection.

9. A method for driving a rapid-discharge unit (263) of the battery system (10, 20) according to claim 3, characterized in that, in the half-bridge (310), a power semiconductor (311) is switched on and another power semiconductor (320) is operated in an active mode as a controllable resistor in order to discharge the electrical energy store.

10. A vehicle comprising a battery system (10, 20) according to claim 1 and at least one electrical energy store.

11. The vehicle according to claim 10, wherein the electrical energy store is a lithium-ion, a lithium-sulfur and/or a lithium-air battery.
